(19) United States
(12) Patent Application Publication
(10) Pub. No.: US 2023/0413972 A1
(43) Pub. Date: Dec. 28, 2023

(54) WATER ION GENERATION DEVICE AND PERSONAL CARE APPLIANCE

(71) Applicant: KONINKLIJKE PHILIPS N.V., EINDHOVEN (NL)

(72) Inventor: Hiu Man LAM, HONG KONG (CN)

(21) Appl. No.: 18/037,792

(22) PCT Filed: Nov. 17, 2021
(86) PCT No.: PCT/EP2021/081908

§ 371 Date: May 19, 2023

(30) Foreign Application Priority Data
Nov. 24, 2020 (EP) 20209546.9

(51) Int. Cl. A45D 20/12; H01T 19/04; H01T 23/00

(52) U.S. Cl. CPC A45D 20/12; H01T 19/04; H01T 23/00; A45D 2200/202

(57) ABSTRACT

In the context of water ion generation, it is advantageous to apply water absorption material that is configured to absorb water from the air at temperatures below an absorption threshold and to release water to the air at temperatures above the absorption threshold. In view thereof, a water ion generation device (10) is provided that comprises at least one absorption body (14) comprising such material, and that further comprises an electrode arrangement (11) configured to perform an ionizing action on water in the air for generating water ions, the electrode arrangement (11) including a discharge electrode (12) and an electric circuit configured to apply a high voltage to the discharge electrode (12), wherein the discharge electrode (12) is generally shaped like a pin and the absorption body (14) is arranged in the vicinity of a tip portion (12a) of the discharge electrode (12).

### FIELD OF THE INVENTION

The invention relates to a water ion generation device, comprising an electrode arrangement configured to perform an ionizing action on water in the air for generating water ions, the electrode arrangement including a discharge electrode and an electric circuit configured to apply a high voltage to the discharge electrode.

Further, the invention relates to a personal care appliance comprising a housing and a water ion generation device as described here before accommodated in the housing.

### BACKGROUND OF THE INVENTION

In the field of hair care, which is a type of personal care, appliances are known which are capable of subjecting hair to a moisturizing action by providing an ion mist to the hair. Such appliances are equipped with an electrostatic atomizer that is configured to electrostatically atomize water, so that during operation, an ion mist containing water radicals is generated. In general, an electrostatic atomizer includes a discharge electrode, a counter electrode located to face a tip portion of the discharge electrode, and supply means for supplying water to the discharge electrode. When a high voltage is applied to the discharge electrode, water as present on the tip portion of the discharge electrode is atomized to generate the ion mist. In many practical cases, a negative pulse is applied to the discharge electrode so as to obtain negative ions, i.e. hydroxide ions.

In the conventional situation, the discharge electrode is cooled by means of a cooling unit including a Peltier element, so that the air surrounding the discharge element is cooled and the temperature of the air reaches the dew point or drops to below the dew point. As a result, dew condensation water accumulates on the surface of the discharge electrode. Hence, the supply means for supplying water to the discharge electrode reside in cooling the discharge electrode and thereby promoting condensation of water from the air on the surface of the discharge electrode. Additional measures for enabling a supply of water to at least the tip portion of the discharge electrode may be taken, such as designing the discharge electrode with capillary systems for receiving excessive water, retaining the water and transporting the water to the tip portion, or designing the discharge electrode with one or more special concave water retaining areas at the tip portion.

JP 2009 125415 A discloses a mist separator which includes a light source, a water supply part which has an irradiation surface irradiated with the light from the light source and which supplies the water to the irradiation surface and a water storage tank for replenishing the water to the water supply part. The light source evaporates the water supplied to the irradiation surface with the irradiation light and forms the water into mist. In an arrangement, a Peltier cooling element is used to enable absorption of water on a surface of an insulating plate, the plate acting as the water supply unit.

JP 2008 284202 A discloses a hair dryer provided with a sub ventilation passage separately from a ventilation passage where an air blowing fan and a heater unit are disposed, and a radiator is disposed on the inside of the sub ventilation passage. A discharge part of the ion generator and a heat absorbing portion of a thermoelectric conversion part constituting a cooling device is disposed facing the ventilation passage. A dry air fed by the air blowing fan before being heated by the heater unit is introduced in the sub ventilation passage. The discharge part is disposed on the upstream side of the heat absorber portion and negative ions generated by the discharge part are forcibly cooled by the absorbing portion.

### SUMMARY OF THE INVENTION

It is an object of the invention to provide a water ion generation device that is configured to rely on another principle for supplying water to be ionized than the conventional principle of promoting condensation of water on the discharge electrode. The invention is defined by the independent claims. The dependent claims define advantageous embodiments.

In view of the foregoing, one aspect of the invention provides a water ion generation device, comprising: i) at least one absorption body comprising water absorption material that is configured to absorb water from the air at temperatures below an absorption threshold and to release water to the air at temperatures above the absorption threshold, and ii) an electrode arrangement configured to perform an ionizing action on water in the air for generating water ions, the electrode arrangement including a discharge electrode and an electric circuit configured to apply a high voltage to the discharge electrode, wherein the discharge electrode is generally shaped like a pin and the at least one absorption body is arranged in the vicinity of a tip portion of the discharge electrode.

In the first place, as already explained in relation to the background art, the water ion generation device comprises an electrode arrangement including a generally pin-shaped discharge electrode having a tip end, and an electric circuit configured to apply a high voltage to the discharge electrode. In the second place, the water ion generation device according to the invention comprises at least one absorption body comprising water absorption material that is configured to absorb water from the air at temperatures below an absorption threshold and to release water to the air at temperatures above the absorption threshold, wherein the at least one absorption body is arranged in the vicinity of the tip portion of the discharge electrode. The at least one absorption body may be mounted in the water ion generation device in any suitable practical way. In the water ion generation device according to the invention, supply of water towards at least the tip portion of the discharge electrode is realized when the temperature is above the absorption threshold of the water absorption material of the at least one absorption body so that release of water from the at least one absorption body to the air takes place. In view of the fact that the at least one absorption body is in the vicinity of the tip portion of the discharge electrode, the water is ionized when the electric circuit of the electrode arrangement is operated to apply a high voltage to the discharge electrode.

An important advantage of the invention becomes readily apparent when an application of the water ion generation device in the context of a personal care appliance comprising a heater device is considered. Practical examples of such a personal care appliance include a heated hair dryer, a heated hair styler, and a heated air brush. In the conventional situation, in a process of designing such a personal care appliance, it is challenge to deal with the contradiction of having both a general air heating functionality and a local air cooling functionality in the same appliance. Contrariwise, when the invention is put to practice, it is the general air heating functionality that can be used for supplying water to be ionized by means of the discharge electrode. In this respect, it is noted that it is possible to choose a type of water absorption material of the at least one absorption body that has an absorption threshold higher than room temperature, i.e. a temperature in a range of about 18° C. to 25° C., and lower than temperatures related to operation of the heater device, so that the material absorbs water when the appliance is not in use and the material releases water when the appliance is in use, i.e. during the exact time that supply of water is needed.

In the framework of the invention, practical options relating to the shape and positioning of the at least one absorption body include the following: i) the at least one absorption body is generally shaped like a hollow cylinder and encompasses the tip portion of the discharge electrode at close range, ii) the at least one absorption body is generally shaped like a hollow cylinder and is located right in front of the tip portion of the discharge electrode, iii) the at least one absorption body is generally shaped like a hollow cylinder, wherein a first portion of the at least one absorption body encompasses the tip portion of the discharge electrode at close range, and wherein a second portion of the at least one absorption body is located right in front of the tip portion of the discharge electrode, and iv) the at least one absorption body is generally block-shaped and is arranged at least partially alongside the tip portion of the discharge electrode. In respect of the first three options, it is noted that it may be practical if the at least one absorption body is at a position that is substantially coaxial with the discharge electrode, as in that way, a highest quantity of water that is put under the influence of the tip of the discharge electrode can be achieved. In respect of the fourth option, it is noted that it may be so that the water ion generation device comprises at least two absorption bodies which are generally block-shaped, wherein each of the at least two absorption bodies is arranged at least partially alongside the tip portion of the discharge electrode, and wherein the at least two absorption bodies are located at different sides of the tip portion of the discharge electrode. In any case, the at least one generally block-shaped absorption body may have a generally straight appearance, but it is also possible that the generally block-shaped absorption body has a generally curved appearance so as to be able to more closely follow the outer surface of the tip portion of the discharge electrode.

As suggested in the foregoing, it may be advantageous if the water absorption material of the at least one absorption body has an absorption threshold higher than room temperature, so that the at least one absorption body can function to absorb water under normal, non-heated or non-operated (hence, self-absorbing) circumstances. Since the at least one absorption body absorbs water at a suitable temperature higher than room temperature, preferably closer to room temperatures, the invention also eliminates the use of active cooling units like Peltier elements which are normally used to induce condensation on absorption bodies in water ion generation devices. This in turn makes a personal care device which includes the water absorption material of the present solution cheaper to manufacture.

It may be practical if the generally pin-shaped discharge electrode has a generally circular periphery. Further, it may be practical if the tip portion of the discharge electrode has a generally conical shape. The electrode arrangement may further include a counter electrode, in which case it may be so that the counter electrode is generally shaped like a ring and is located in front of the tip portion of the discharge electrode, at a distance from the tip portion of the discharge electrode.

The invention further relates to a personal care appliance that comprises a housing and a water ion generation device as described here before accommodated in the housing. The personal care appliance may particularly be a hair care appliance. In the framework of the invention, the following options are applicable to the personal care appliance: i) the personal care appliance comprises a heater device configured to heat the air inside the housing, ii) the water absorption material of the at least one absorption body of the water ion generation device has an absorption threshold higher than room temperature and lower than temperatures related to operation of the heater device, iii) the personal care appliance comprises an air displacement device configured to generate a flow of air through the housing, and iv) in the case that the personal care appliance comprises both the heater device and the air displacement device, the water ion generation device is located in the same area of the housing as the heater device or downstream of the heater device, seen in the direction of the flow of air. The optional heater device may be of any suitable design and may comprise one or more heating coils, for example. A practical example of the optional air displacement device is a ventilator.

The above-described and other aspects of the invention will be apparent from and elucidated with reference to the following detailed description of practical embodiments of a water ion generation device in the context of a hair care appliance as an example of a personal care appliance.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a water ion generation device according to a first embodiment of the invention in the context of a hair care appliance,

FIG. 2 diagrammatically shows a discharge electrode and an absorption body of the water ion generation device according to the first embodiment of the invention,

FIG. 3 diagrammatically shows a water ion generation device according to a second embodiment of the invention in the context of the hair care appliance,

FIG. 4 diagrammatically shows a discharge electrode and two absorption bodies of the water ion generation device according to the second embodiment of the invention,

FIG. 5 illustrates absorption of water by an absorption body of a water ion generation device according to a third embodiment of the invention, and

FIG. 6 illustrates release of water from the absorption body of the water ion generation device according to the third embodiment of the invention and ionizing of the water.

### DETAILED DESCRIPTION OF EMBODIMENTS

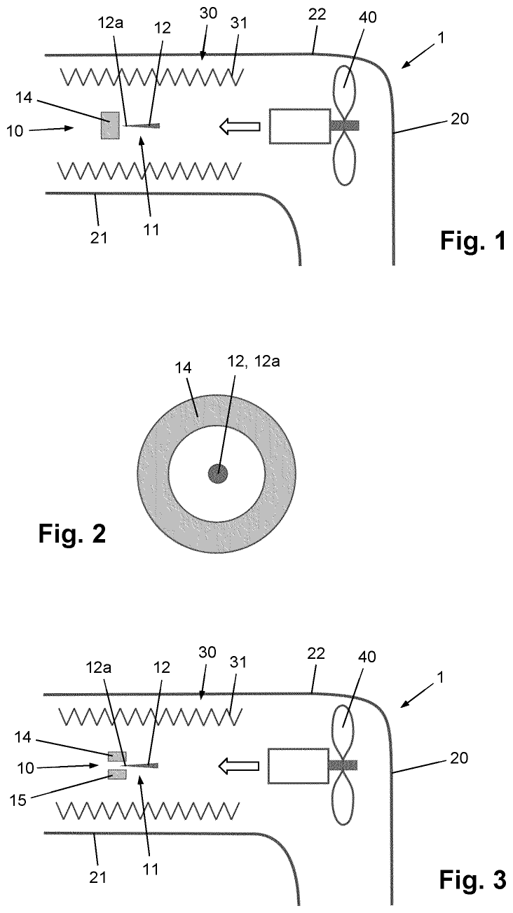

FIG. 1 diagrammatically shows a water ion generation device 10 according to a first embodiment of the invention in the context of a hair care appliance 1.

The hair care appliance 1 is suitable to be used as a heated hair dryer, for example, and comprises, besides the water ion generation device 10, a housing 20, a heater device 30 configured to heat the air inside the housing 20, and an air displacement device 40 configured to generate a flow of air through the housing 20. The direction of the flow of air that is generated by the air displacement device 40 is indicated in FIG. 1 by means of a hollow arrow. The water ion generation device 10 and the heater device 30 are located in a first portion 21 of the housing 20 that is downstream of a second portion 22 of the housing 20 where the air displacement device 40 is located. Seen in the direction of the flow of air, the water ion generation device 10 is located in the same area of the housing 20 as the heater device 30. In the shown example, the heater device 30 comprises two or more heating coils 31 which extend in the direction of the flow of air and which are distributed over an inner periphery of the first portion 21 of the housing 20, and the water ion generation device 10 is located in a space encompassed by the heating coils 31.

The water ion generation device 10 comprises an electrode arrangement 11 configured to perform an ionizing action on water in the air, which involves generating water ions by breaking down water molecules. The hair care appliance 1 may be operable in a number of different operation modes, wherein at least one of those operation modes involves an active state of the water ion generation device 10, the heater device 30 and the air displacement device 40, so that the hair care appliance 1 is enabled to output a hot flow of air carrying an ion mist including water ions. Exposing hair to the hot flow of air carrying the ion mist including water ions is beneficial to the condition of the hair.

The electrode arrangement 11 of the water ion generation device 10 includes a discharge electrode 12 and an electric circuit configured to apply a high voltage to the discharge electrode 12. In FIG. 1, only the discharge electrode 12 is diagrammatically shown. The discharge electrode 12 is generally shaped like a pin in projecting arrangement, wherein it is advantageous if at least a tip portion 12a of the discharge electrode 12 has a generally conical shape. When the water ion generation device 10 is operated, water that is present in the air surrounding the tip portion 12a of the discharge electrode 12 is ionized.

Besides the electrode arrangement 11, the water ion generation device 10 comprises at least one absorption body 14, 15 comprising water absorption material that is configured to absorb water from the air at temperatures below an absorption threshold and to release water to the air at temperatures above the absorption threshold. The at least one absorption body 14, 15 is arranged in the vicinity of the tip portion 12a of the discharge electrode 12. It is advantageous if the water absorption material of the at least one absorption body 14, 15 has an absorption threshold higher than room temperature and lower than temperatures related to operation of the heater device 30, wherein the latter temperatures may be 60° C. or higher in the context of a heated hair dryer. In that way, it is achieved that the at least one absorption body 14, 15 absorbs water from the air during the time preceding to operation of the hair care appliance 1, and that the at least one absorption body 14, 15 releases water to the air during the time that the hair care appliance 1 is operated and the at least one absorption body 14, 15 is heated as a result of the heater device 30 being in an active state. In the latter case, in view of the fact that the at least one absorption body 14, 15 is arranged in the vicinity of the tip portion 12a of the discharge electrode 12, the release of water is directly towards the very area where the water is to be ionized under the influence of a high voltage at the discharge electrode 12.

The water ion generation device 10 according to the first embodiment of the invention comprises a single absorption body 14. FIG. 2 diagrammatically shows the discharge electrode 12 and the absorption body 14. In the first place, it can be seen in FIG. 2 that the discharge electrode has a generally circular periphery. In the second place, it can be seen in FIG. 2 that the absorption body 14 is generally shaped like a hollow cylinder, and it can be seen in FIG. 1 that the absorption body 14 is located right in front of the tip portion 12a of the discharge electrode 12, wherein the absorption body 14 is at a position that is substantially coaxial with the discharge electrode 12. In this configuration, when the temperatures are high enough for the absorption body 14 to release water, at least the water that is released at the position of the interior space of the absorption body 14 and at the position of the end of the absorption body 14 facing the discharge electrode 12 is directly in the ionizing area.

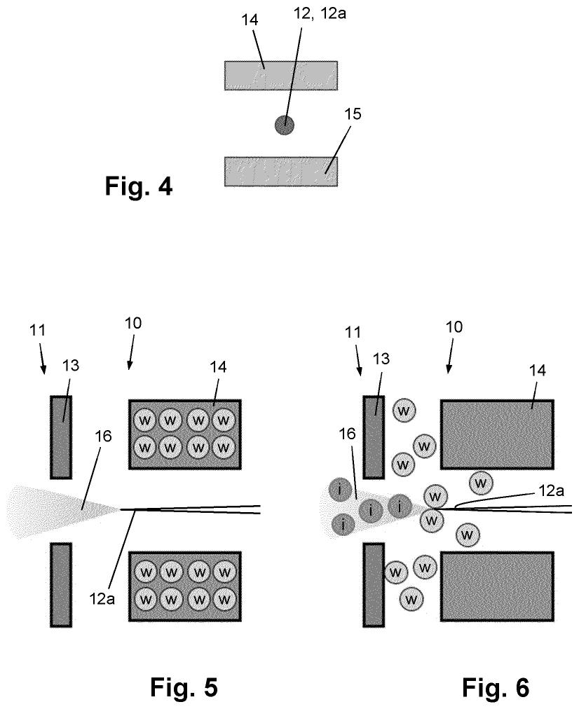

FIG. 3 diagrammatically shows a water ion generation device 10 according to a second embodiment of the invention in the context of the hair care appliance 1. The water ion generation device according to the second embodiment of the invention comprises two absorption bodies 14, 15. FIG. 4 diagrammatically shows the discharge electrode 12 and the absorption bodies 14, 15. It can be seen in FIGS. 3 and 4 that the absorption bodies 14, 15 are generally block-shaped and that the absorption bodies 14, 15 are located at different, opposite sides of the tip portion 12a of the discharge electrode 12, and it can be seen in FIG. 3 that each of the absorption bodies 14, 15 is arranged partially alongside the tip portion 12a of the discharge electrode 12, wherein a first portion of each of the absorption bodies 14, 15 extends alongside the tip portion 12a of the discharge electrode 12, and wherein a second portion of each of the absorption bodies extends right in front of the tip portion 12a of the discharge electrode 12. In this configuration, when the temperatures are high enough for the absorption bodies 14, 15 to release water, at least the water that is released at the position of surfaces of the absorption bodies 14, 15 facing each other is directly in the ionizing area.

FIG. 5 illustrates absorption of water by an absorption body 14 of a water ion generation device 10 according to a third embodiment of the invention, and FIG. 6 illustrates release of water from the absorption body 14 of the water ion generation device 10 according to the third embodiment of the invention and ionizing of the water. In the water ion generation device 10 according to the third embodiment of the invention, the absorption body 14 is generally shaped like a hollow cylinder and encompasses the tip portion 12a of the discharge electrode 12 at close range. Further, in the water ion generation device 10 according to the third embodiment of the invention, the electrode arrangement 11 includes a counter electrode 13. FIGS. 5 and 6 are to be regarded as sectional views of the tip portion 12a of the discharge electrode 12, the counter electrode 13 and the absorption body 14. It is practical if the counter electrode 13 is generally shaped like a ring and is located in front of the tip portion 12a of the discharge electrode 12, at a distance from the tip portion 12a of the discharge electrode 12, as illustrated in FIGS. 5 and 6, which does not alter the fact that other shapes and/or other locations of the counter electrode 13 are feasible as well. In FIG. 5, water that is absorbed and held by the absorption body 14 is represented by light-colored circles indicated w. In FIG. 6, water that is released from the absorption body 14 is also represented by light-colored circles indicated w, and water ions are represented by dark-colored circles indicated i. An area 16 where emission of the water ions takes place is shown as an area 16 of conical shape right in front of the tip portion 12a of the discharge electrode 12.

The at least one absorption body 14, 15 of the water ion generation device 10 may have any suitable shape and size and may be located at any suitable position relative to the tip portion 12a of the discharge electrode 12 for the purpose of obtaining an effective water ionizing action through release of water directly in an ionizing area of the discharge electrode 12. The invention covers any feasible application of the water ion generation device 10 comprising the at least one absorption body 14, 15 and the electrode arrangement 11 in a larger context such as the context of a personal care appliance. The water absorption material of the at least one absorption body 14, 15 may be of any suitable type, wherein it is possible to choose the type of material on the basis of expected or generated temperatures associated with a situation in which the at least one absorption body 14, 15 is to absorb water and a situation in which the at least one absorption body 14, 15 is to release water, respectively.

In all the above embodiments, the water absorption material of the at least one absorption body 14, 15, preferably has an absorption threshold higher than room temperature.

It will be clear to a person skilled in the art that the scope of the invention is not limited to the examples discussed in the foregoing, but that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in this text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

Notable aspects of the invention are summarized as follows. In the context of water ion generation, it is advantageous to apply water absorption material that is configured to absorb water from the air at temperatures below an absorption threshold and to release water to the air at temperatures above the absorption threshold. The water absorption material of the at least one absorption body preferably has an absorption threshold higher than room temperature. In view thereof, a water ion generation device 10 is provided that comprises at least one absorption body 14, 15 comprising such water absorption material, and that further comprises an electrode arrangement 11 configured to perform an ionizing action on water in the air for generating water ions, the electrode arrangement 11 including a discharge electrode 12 and an electric circuit configured to apply a high voltage to the discharge electrode 12, wherein the discharge electrode 12 is generally shaped like a pin and the at least one absorption body 14, 15 is arranged in the vicinity of a tip portion 12a of the discharge electrode 12.

1. Water ion generation device, comprising:
at least one absorption body comprising water absorption material that is configured to absorb water from the air at temperatures below an absorption threshold and to release water to the air at temperatures above the absorption threshold, and
an electrode arrangement configured to perform an ionizing action on water (w) in the air for generating water ions (i), the electrode arrangement including a discharge electrode and an electric circuit configured to apply a high voltage to the discharge electrode,
wherein the discharge electrode is generally shaped like a pin and the at least one absorption body is arranged in the vicinity of a tip portion of the discharge electrode,
wherein the water absorption material of the at least one absorption body has an absorption threshold higher than room temperature.

2. Water ion generation device according to claim 1, wherein the at least one absorption body is generally shaped like a hollow cylinder and encompasses the tip portion of the discharge electrode at close range.

3. Water ion generation device according to claim 1, wherein the at least one absorption body is generally shaped like a hollow cylinder and is located right in front of the tip portion of the discharge electrode.

4. Water ion generation device according to claim 1, wherein the at least one absorption body is generally shaped like a hollow cylinder, wherein a first portion of the at least one absorption body encompasses the tip portion of the discharge electrode at close range, and wherein a second portion of the at least one absorption body is located right in front of the tip portion of the discharge electrode.

5. Water ion generation device according to claim 2, wherein the at least one absorption body is at a position that is substantially coaxial with the discharge electrode.

6. Water ion generation device according to claim 1, wherein the at least one absorption body is generally block-shaped and is arranged at least partially alongside the tip portion of the discharge electrode.

7. Water ion generation device according to claim 6, comprising at least two absorption bodies which are generally block-shaped, wherein each of the at least two absorption bodies is arranged at least partially alongside the tip portion of the discharge electrode, and wherein the at least two absorption bodies are located at different sides of the tip portion of the discharge electrode.

8. Water ion generation device according to claim 1, wherein the tip portion of the discharge electrode has a generally conical shape.

9. Water ion generation device according to claim 1, wherein the electrode arrangement further includes a counter electrode, and wherein the counter electrode is generally shaped like a ring and is located in front of the tip portion of the discharge electrode, at a distance from the tip portion of the discharge electrode.

10. Personal care appliance (1), comprising a housing and a water ion generation device according to claim 1 accommodated in the housing.

11. Personal care appliance according to claim 10, comprising a heater device configured to heat the air inside the housing.

12. Personal care appliance (1) according to claim 11, wherein the water absorption material of the at least one absorption body of the water ion generation device has an absorption threshold higher than room temperature and lower than temperatures related to operation of the heater device.

13. Personal care appliance according to claim 10, comprising an air displacement device configured to generate a flow of air through the housing.

14. Personal care appliance according to claim 13, wherein the water ion generation device is located in the same area of the housing as the heater device or downstream of the heater device, seen in the direction of the flow of air.
